(19) United States
(12) Patent Application Publication
(10) Pub. No.: US 2024/0283328 A1
(43) Pub. Date: Aug. 22, 2024

(54) ROTATION ENERGY HARVESTER

(71) Applicant: Enervibe Ltd., Airport City (IL)

(72) Inventors: Dan Haronian, Efrat (IL); Michael Haronian, Tzur Hadasa (IL)

(73) Assignee: Enervibe Ltd., Airport City (IL)

(21) Appl. No.: 18/290,021

(22) PCT Filed: May 2, 2022
(86) PCT No.: PCT/IL2022/050449

§ 371 Date: Nov. 9, 2023

Related U.S. Application Data
(60) Provisional application No. 63/187,937, filed on May 13, 2021.

(51) Int. Cl. H02K 7/18; D06F 34/05; D06F 34/10; D06F 34/20; D06F 103/00; H02K 7/10; H02K 11/35

(52) U.S. Cl. CPC H02K 7/1869; D06F 34/05; D06F 34/10; D06F 34/20; H02K 7/1004; H02K 11/35; D06F 2103/00

(57) ABSTRACT

A monitored drive belt of a machine that includes a drive belt (3), a module (1) fixed to the drive belt that includes an electromagnetic device (11) with two terminals (1111) and (1112) and an electric device (12), a magnet (22) fixed to a body of the machine at close proximity to a path of module (1) when the drive belt rotates. The electric device includes a power management circuit (121) that is connected to the two terminals (1111) (11112), an electric power storing device (122), at least one sensor (123) that is designed to sense surrounding condition or condition of the drive belt itself, and a data transmission means (124), and such that when the driving belt rotates the magnet can induces electric voltage between the two terminals of the electromagnetic device, and such that the voltage can be managed by the power management circuit and such that the power management circuit can charge the electric power storing device, and power the sensor and the data transmission means.

### BACKGROUND OF THE INVENTION

Health and performance monitoring of machine becomes a major avenue in machine smart controlling. Health Monitoring of machines allows detecting critical faults before they occur. Autonomous machines allow the machine to perform based in a changing environment without the need for human intervention. In most cases the power for monitoring health or performance comes from the machine power source. Yet, in some cases the location of the monitoring sensor is at places where power cannot be supplied. Among such cases are rotating parts such as belt on a pulley and washing machine drum, automotive wheel and alike.

### SUMMARY OF THE INVENTION

This patent application is related to rotation energy harvester that harvests electric power from rotation of bodies. The harvested energy may be used to power sensors for health and performances monitoring and RF communication for data transmission and RF control.

### BRIEF DESCRIPTION OF THE DRAWINGS

FIG. 1 depicts a general view of the Rotation Energy Harvester.

FIG. 2 depicts schematics of the Rotation Energy Harvester.

FIGS. 3a and 3b depict an embodiment of Rotation Energy Harvester for a rotating belt.

FIG. 4 depicts an embodiment of Rotation Energy Harvester for a washing machine.

FIGS. 5a and 5b depict the Rotation Energy Harvester for a washing machine.

### DETAILED DESCRIPTION OF THE INVENTION

This patent application is related to harvesting electric power from rotation of bodies. Specifically, for harvesting electric power from rotation in cases where electric devices are placed on a rotating body without a line power source. In such case a battery may be used with limited lifetime and performance that are dedicated by the available battery capacity. The harvested energy described in this patent application comprise a at least one coil fixed to the rotating part and at least one magnet fixed to the chassis of the body such that during rotation the coil passes close to the magnet that induces voltage drop between the coil ends. The coil wire can be wound around a core such that the core passes close to the magnet that induces voltage drop between the coil ends

Equation 1 describes the Electromotive force measured in volts developed between the coil ends.

$$E = - N \cdot d Φ / dt \qquad ( 1 )$$

N is the number of turns of the coil, and Φ is the magnetic flux. Moving a magnet relative to a coil generates dΦ/dt. Clearly the large dΦ/dt the larger E and therefore the higher the rotation speed of the rotating body the higher the generated electric power.

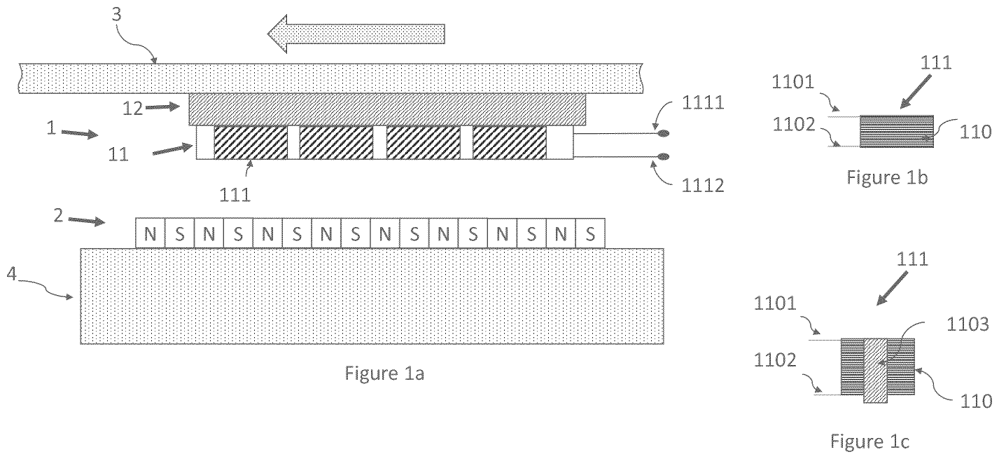

FIG. 1 is a general embodiment of a Rotation Energy Harvester of a moving body (2) that cyclically moves relative to a stationary body (4). In this embodiment, module (1) is fixed to the moving body, and module (2) comprise at least one magnet fixed to the stationary body such that the magnetic poles are along the moving direction of the moving body. Module (1) includes an electromagnetic device (11) and an electric circuit (12). The electromagnetic device (11) may comprise at least one element (111) that may be coil (110) with two ends (1101) and (1102) as shown in FIG. 1b or at least one core (11103) winded by a coil (110) with two ends (1101) and (1102) as shown in FIG. 1c. The coils from different elements (111) may be connected to each other in serial or in parallel such that two terminals (1111, 1112) emerge from the module that are fed to the electric circuit. As the moving part (3) moves relative to the stationary part (4), device (1) moves relative to the magnet (2) such that voltage drop develops between terminals (1111) and (1112).

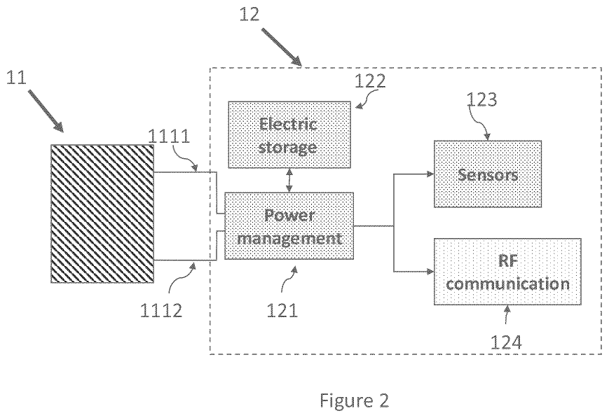

One embodiment of the electric circuit (12) is described in FIG. 2. The modules comprise a power management (121) that rectifies the voltage generated between terminal (1111) and (1112) and manages the electric properties such that the generated power is suitable to power an electric storage device (122), and devices such as sensors (123) and RF communication device (1024). The electric storage device may be for example a rechargeable battery or super capacitor.

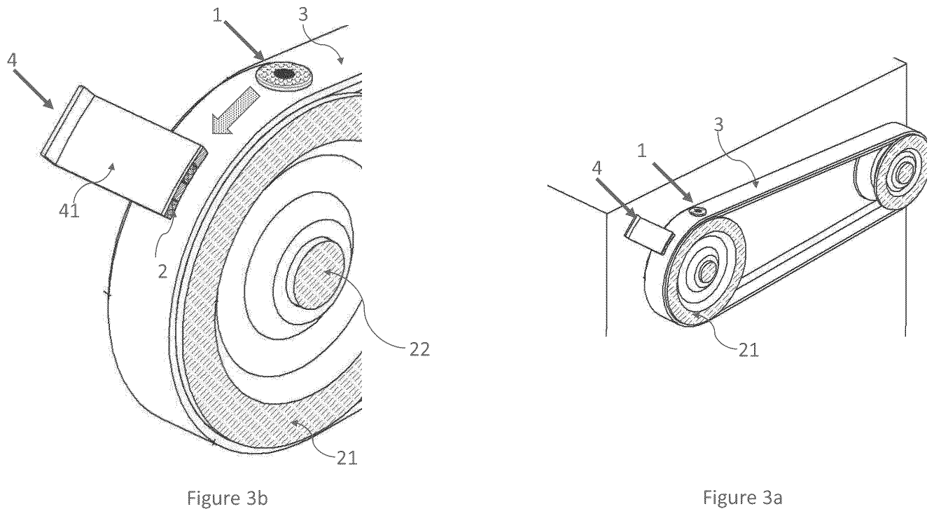

FIG. 3 describes a rotation energy harvester comprising modules (1) and (2) described in FIGS. 1 and 2. Module (1) is fixed to a rotating belt and module (2) is fixed a stationary body (4). The harvested energy powers sensors that monitor the health of the belt and the forces applied on the belt.

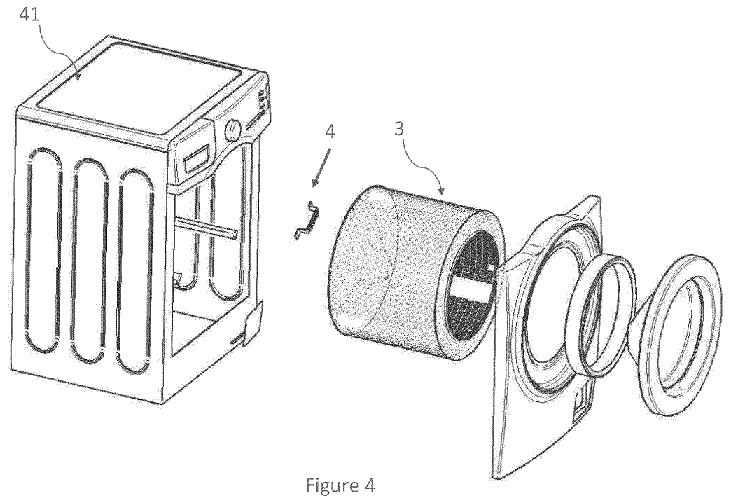

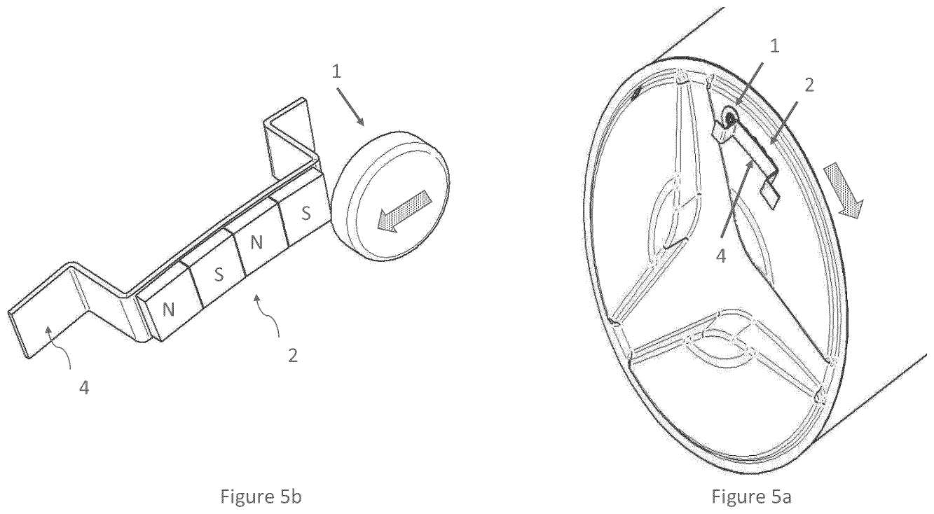

FIGS. 4 and 5, describe a washing machine (41) with a rotation harvester (1), (2) described in FIGS. 1 and 2. In the embodiment shown in FIGS. 4 and 5, the magnet (2) is connected to the washing machine (41) through a metal bridge (4). Device (1) is fixed to the washing machine drum (3). The harvested energy powers sensors that monitor the health of the washing machine, the forces applied on the drum and properties of the washing cycle.

1. A monitored drive belt of a machine, comprising:
a drive belt (3),
a module (1) fixed to the drive belt comprising an electromagnetic device (11) with two terminals (1111) and (1112) and an electric device (12),
a magnet (22) fixed to a body of the machine at close proximity to a path of module (1) when the drive belt rotates,
wherein the electric device includes a power management circuit (121) that is connected to said two terminals (1111) (11112), an electric power storing device (122), at least one sensor (123) that is designed to sense surrounding condition or condition of the drive belt itself, and a data transmission means (124), and
Such that when the driving belt rotates the magnet can induces electric voltage between the two terminals of the electromagnetic device, and such that the voltage can be managed by the power management circuit and such that the power management circuit can charge the electric power storing device, and power the sensor and the data transmission means.

2. The monitored drive belt according to claim 1 that further includes one or more additional electromagnetic devices wherein each of said electromagnetic devices is a coil (110) with a positive end (1101) and a negative end (1102) such that the coils are connected in series with polarity that sums positive value of voltage developed in each coil or connected in parallel with polarity that sums positive value of current flowing in each coil and such that the resulting two ends are connected to said terminals.

3. A monitored drive belt according to claim 2 wherein each of said coils is winded on a core (1103) and wherein said magnet is at close proximity to a path of the cores when the drive belt rotates

4. A monitored drum of a washing machine or drying machine, comprising:
a washing machine or drying machine drum (41),
a module (1) fixed to the machine drum comprising an electromagnetic device (11) with two terminals (1111) and (1112) and an electric device (12)
a magnet (22) fixed to a body of the machine at close proximity to a path of module (1) when the drum rotates,
wherein the electric device includes a power management circuit (121) that is connected to two terminals (1111) (11112), an electric power storing device (122), at least one sensor (123) that is designed to sense surrounding condition or condition of the drum itself, and a data transmission means (124), and
Such that when the drum rotates the magnet can induces electric voltage between the two terminals of the electromagnetic device, and such that the voltage can be managed by the power management circuit and such that the power management circuit can charge the electric power storing device, and power the sensor and the data transmission means.

5. The monitored drum according to claim 4 that further includes one or more additional electromagnetic devices wherein each of said electromagnetic devices is a coil (110) with a positive end (1101) and a negative end (1102) such that the coils are connected in series with polarity that sums positive value of voltage developed in each coil or connected in parallel with polarity that sums positive value of current flowing in each coil and such that the resulting two ends are connected to said terminals.

6. The monitored drum according to claim 5 wherein each of said coils is winded on a core (1103) and wherein said magnet is at close proximity to a path of the cores when the drive belt rotates
